(19) United States
(12) Patent Application Publication
(10) Pub. No.: US 2024/0135118 A1
(43) Pub. Date: Apr. 25, 2024

(54) HYBRID ANALOG AND DIGITAL COMPUTATIONAL SYSTEM

(71) Applicant: University of Central Florida Research Foundation, Inc., Orlando, FL (US)

(72) Inventors: Pang SHUO, Orlando, FL (US); Guifang LI, Orlando, FL (US); Zheyuan ZHU, Orlando, FL (US)

(21) Appl. No.: 18/546,882

(22) PCT Filed: Feb. 19, 2021
(86) PCT No.: PCT/US2021/018709

§ 371 Date: Aug. 17, 2023

(51) Int. Cl. G06J 1/00

(52) U.S. Cl. CPC G06J 1/00

(57) ABSTRACT

A hybrid analog and digital computational system is created by receiving equations in which a set of solution values is unknown. A residual iterative algorithm is implemented to solve the set of solution values for the equations. The residual iterative algorithm includes an outer update loop computed using a digital computing device with a set of residue values initially set to a first initial value and a set of solution update values set to a second initial value. The residual iterative algorithm includes an inner residual loop, which is iteratively computed using an analog accelerator until one or more inner residual loop stopping criteria is met and returning the set of solution update values. Next, the set of solution updates are used to update the set of residue values and a range of a next set of solution update values, thereby adjusting a computational precision of the inner residual loop.

### BACKGROUND

The present application relates generally to a hybrid analog and digital computational system more specifically to hybrid analog and digital computational system to solve a set of one or more equations in which a set of solution values is unknown.

This application includes references denoted in brackets with numbers, e.g. [x] where x is a number. This numeric listing of the references is found at the end of this application. Further, these references are listed in the information disclosure statement (IDS) filed herewith. The teachings of each of these listed references are hereby incorporated hereinto by reference in their entirety.

Recent progress in high-performance computing has a profound and broad impact in science, technology, economy, and our society at large. More accurate numerical models allow today's 120-hour hurricane forecasts to achieve the same accuracy as 48-hour forecasts a decade ago [1]; machine learning (ML) algorithms based on neural networks have demonstrated remarkable progress in many areas [2]-[4]. Solving systems of equations and performing optimizations are ubiquitous in these applications, and digital processors are by far the most common tools for these tasks.

In the post-Moore's law era, despite the stagnation in processing power of general-purpose processors, special-purpose electronic accelerators, such as field-programmable gate array (FPGA), graphic processing unit (GPU) and other application-specific integrated circuits (ASICs), play indispensable roles in the progress of high-performance computing. Digital electronic accelerators have already been pushed to their limits in boosting their scalability and energy efficiency [5]. Analog computing is being considered as an alternative computing paradigm [6]. Against this backdrop, there has been a regained attention in optical analog computing [7], [8]. Different from previous attempts in creating digital all-optical computers, these renewed efforts demonstrate optical schemes, such as neuromorphic computing [9]-[14] and reservoir computing [15]-[21], which does not have strict requirement in precision.

The overall goal of the research program is to develop a hybrid photonic iterative solver (PIS) with the aim of solving large-scale systems of equations and optimization problems, which takes the best of both worlds: analog photonics for high-efficiency, high-speed computing, and digital electronics for programming, storage, and precision control. The proposed computing platform 1) provides a scalability that is orders-of-magnitude larger than digital processors, 2) is fast, energy efficient, and reliable, and 3) is programmable to correct device imperfection and exceed the precision limited by analog devices.

### SUMMARY OF THE INVENTION

The invention is a directed to novel system, computer program product, and method of creating of hybrid analog and digital computational system. The method begins with receiving a set of one or more equations in which a set of solution values is unknown. The set one or more equations may include linear equations or a set of near linear equations. Next, a residual iterative algorithm is implemented to solve the set of solution values for the set of one or more equations. The residual iterative algorithm includes an outer update loop computed using a digital computing device with a set of residue values initially set to a first initial value and a set of solution update values set to a second initial value. The residual iterative algorithm includes an inner residual loop, which is iteratively computed using an analog accelerator until one or more inner residual loop stopping criteria is met and returning set of solution update values. Next, the set of solution updates are used which has been computed to update the set of residue values and a range of a next set of solution update values, thereby adjusting a computational precision of the inner residual loop. Finally, the steps the inner residual loop are repeated until one or more outer update loop stopping criteria is met.

In one example, the inner residual loop and/or the outer update loop stopping criteria is one of time, a number of iterations, a threshold for a set of values that are calculated based on solution update values, a threshold for a set of values that are calculated based on residual values or a combination thereof. The inner residual loop may be computed in parallel and independently from other inner residual loop computations using analog parallel computational techniques.

In another example, the analog accelerator is one of photonic accelerator, a neuromorphic accelerator, a neuromemristive accelerator, a biochemical accelerator, a biomechanical accelerator, an analog AI accelerator, or a combination thereof. The analog accelerator may use coherent mixing in computing large scale linear computations, such as vector-vector, matrix-vector, matrix-matrix, or tensor-tensor multiplications. The analog accelerator may also use a degree of freedom in light to encode thereof is one of a wavelength, a spatial mode, a polarization, and a component of a wave vector, or a combination thereof. Still further, the analog accelerator may produce an analog signal which is converted to a fixed-point digital signal with an exponent bit to encode a range of the fixed-point digital signal. Finally, the range of the fixed-point digital signal may be determined by one of i) a current analog signal, ii) a calculation on a digital component of the fixed-point digital signal with a value from a previous iteration, or iii) a combination of both.

In another example, the set of residue values and other set of input values for the inner residual loop are updated with a deterministic calculation or a calculation including randomness. The residual iterative algorithm may solve an equation corresponding to an optimization problem.

In yet another example, the digital computing device adjusts a value of the range. The analog accelerator may use only a value from fixed-point bits and does not use a value from exponent bits. The digital computing device may produce a dynamic fixed-point digital signal which is converted to an analog signal that feeds back to the analog accelerator.

### BRIEF DESCRIPTION THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example illustration of matrix multiplications can be reduced to multiply-accumulate (MAC) operations in which each MAC requires 3 memory reads and 1 memory write, according to the prior art;

FIG. 2 is an example illustration of N×N matrix-vector multiplication requires N2 MACs. Google's TPU has an array of 256×256 MAC units to streamline matrix-vector multiplication, according to the prior art;

FIG. 3 is an example Richardson iteration algorithm, according to the prior art;

FIG. 4 is an example schematic of a photonic iterative solver, according to the prior art;

FIG. 5A is an example illustration of a MDM photonic matrix accelerators, according to the inventors previous patent applications;

FIG. 5B is an example diagram of Mode-division multiplexing implemented by multi-plane light conversion (MPLC) converting single mode in to corresponding Hermite-Gaussian mode, according to the inventors previous patent applications;

FIG. 6 is an example residue iteration algorithm, according to one aspect of the present invention;

FIG. 7 is an example illustration of dynamic fixed-point array and its analog signal equivalent, according to one aspect of the present invention;

FIGS. 8A and 8B are an example illustration of hybrid residual iterative linear system solver, according to one aspect of the present invention;

FIG. 9 is an example schematic of the experimental setup for demonstrating a 3×3 matrix, 3×1 vector multiplication using MDM signals generated using MPLC, according to one aspect of the present invention;

FIG. 10 is an example graphical representation of experimental results of the output of Channel 2, representing the second elements of the output vector, according to one aspect of the present invention;

FIG. 11 is an example illustration of a matrix inversion with fixed-point iterative solver, according to one aspect of the present invention;

FIG. 12 is an example illustration of a matrix inversion with fixed-point iterative solver of FIG. 11 illustrating residue error maps, according to one aspect of the present invention;

FIG. 13 is an example illustration of a matrix inversion with fixed-point iterative solver of FIG. 11 illustrating inversion errors vs. iteration steps using floating-point (dashed curves) and 6-bit fixed-point (solid curves), according to one aspect of the present invention;

FIG. 14A is an example illustration of iterative CT reconstruction with illustration of CT measurement setup according to one aspect of the present invention;

FIG. 14B is an example illustration of iterative CT reconstruction with illustration of CT of FIG. 14A with reconstructed spatial profiles from 4-bit and 6-bit profiles of fixed-point iteration, according to one aspect of the present invention;

FIG. 14C is an example illustration of iterative CT reconstruction with illustration of CT of FIG. 14A with proposed dynamic fixed-point iteration, according to one aspect of the present invention;

FIG. 14D is an example illustration of iterative CT reconstruction with illustration of CT of FIG. 14A with reconstruction errors vs. iteration steps using 4-bit (η=2⁻³) and 6-bit (η=2⁻⁵) iterations and a curve illustrating floating-point iteration, according to one aspect of the present invention;

FIG. 15A and FIG. 15B are an example illustration of parallelized batch matrix-matrix multiplication combining WDM and MDM, according to one aspect of the present invention;

FIG. 16 is a graph of crosstalk matrix of a designed MPLP, according to one aspect of the present invention;

FIG. 17 is an illustration of a DFP thresholding regularization, according to one aspect of the present invention;

FIG. 18 is an example illustration of volumetric x-ray diffraction tomography (XDT) with Schematics of the measurement setup, according to one aspect of the present invention;

FIG. 19 is an example illustration of volumetric x-ray diffraction tomography (XDT) of FIG. 18 with forward measurement model represented as parallel sparse matrices, according to one aspect of the present invention;

FIG. 20 is an example diagram of partial differential equations (PDEs) and the corresponding numerical solution methods, according to one aspect of the present invention;

FIG. 21 is an example illustration of polarization-enabled 1D convolution, according to one aspect of the present invention;

FIG. 22 is an example illustration of polarization-enabled 1D convolution of FIG. 21 with the MPLP is designed to perform a DCT of the inputs, according to one aspect of the present invention;

FIG. 23 is an example illustration of a Helmholtz equation in disordered fiber bundle, according to one aspect of the present invention;

FIG. 24 is an example illustration of solving Helmholtz equation in disordered fiber bundle of FIG. 23 with the 2D Laplacian is expressed with 4th order of accuracy, according to one aspect of the present invention;

FIG. 25 is an example illustration of solving Helmholtz equation in disordered fiber bundle of FIG. 23 with diffusion of wave propagation in ordered structure compared with transverse Anderson localization in disordered fiber, according to one aspect of the present invention;

FIG. 26A is an example illustration of ray tracing in a gradient-index (GRIN) lens from Fermat's principle with ray tracing based on Fermat's principle does not suffer from accumulated error as in using Snell's law, according to one aspect of the present invention;

FIG. 26B is an example illustration of ray tracing in a gradient-index (GRIN) lens from Fermat's principle with the convergence of the ray paths through iterative, according to one aspect of the present invention; and

FIG. 27 is a high-level example overall flow of the process, as described in the preceding figures, according to one aspect of the present invention.

### DETAILED DESCRIPTION

### Non-Limiting Definitions

The terms “a”, “an” and “the” are intended to include the plural forms as well, unless the context clearly indicates otherwise.

The terms “comprises” and/or “comprising”, when used in this specification, specify the presence of stated features, steps, operations, elements, and/or components, but do not preclude the presence or addition of one or more other features, integers, steps, operations, elements, components, and/or groups thereof.

The term “analog accelerator” is a system in which the value of a data item is presented by a continuously variable physical quantity that can be measured. In other example analog accelerators use analog, as opposed to digital, functional units that can solve equations, which state the time derivatives of variables as functions of the variables. In another example the analog functional units are connected using cross-bar architectures as part of deep learning systems. Analog accelerators come in various forms including a neuromorphic accelerator, a neuromemristive accelerator, a biochemical accelerator, a biomechanical accelerator, and an analog AI accelerator.

The term “digital computing device” means any class of computational devices capable of solving problems by processing information in discrete form. Examples of a digital computing device includes semiconductor microprocessor based system that vary widely in form-factor and size.

The term “equations” in mathematics means a statement that asserts an equality of two expressions. Examples of equations include algebraic equations, such as near linear equations, and linear equations, differential equations and integral equations. Linear equations expressed in a matrix terms as y=Ax

The term “element-to-orthogonal degree of freedom (DOF)/dimension of light mapping” is a correspondence between matrix or vector elements to independent parameters of light, including a wavelength, a spatial mode, a polarization, a quadrature, and a component of wave vector.

The term “hyperdimension” means consisting of combinations of two or more degree of freedoms (DOFs)/dimensions of light.

The term “near-linear equation” are equations that can be approximated by the first order. Such a near-linear equation can be approximately by a straight line for at least a portion of its values.

The term “subset of a dimension or hyperdimension” means a subset of independent parameters in one degree of freedom (DOF)/dimension of light or one hyperdimension of light.

The term “light” is electromagnetic radiation that includes both visible and non-visible portions of the light spectrum.

### Background

### 1.1. Digital Computing Bottleneck in Matrix Multiplication

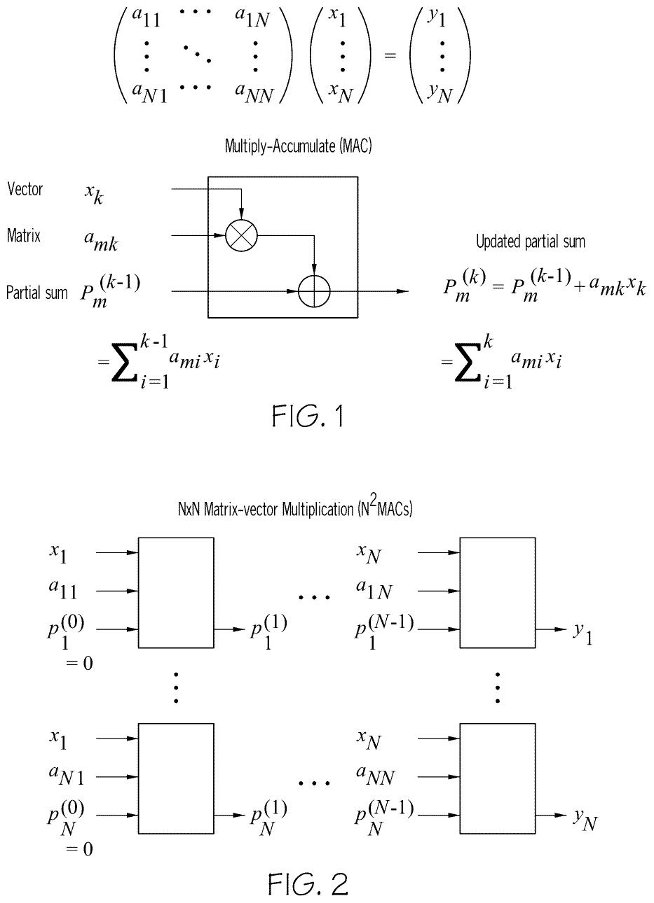

Linear systems are used to model a large class of problems in science and engineering, where the fundamental operations are matrix-matrix and matrix-vector multiplications. Matrix multiplication can be decomposed into multiply-accumulate (MAC) operations. Turning to FIG. 1 is an example illustration of matrix multiplications can be reduced to multiply-accumulate (MAC) operations in which each MAC requires 3 memory reads and 1 memory write. And FIG. 2 is illustration of N×N matrix-vector multiplication requires N2 MACs. Google's TPU has an array of 256×256 MAC units to streamline matrix-vector multiplication. Though one may push process parallelization and the clock speed in performing MAC, the performance of a microprocessor is ultimately limited by on-chip power dissipation. A key metric to evaluate power efficiency is energy consumption per MAC. In modern microprocessors, per data access, dynamic random-access memory (DRAM) consumes two orders of magnitude more power than local on-chip static random-access memory (SRAM)[22]. Three memory READs and 1 memory WRITE are required for each MAC. Digital accelerators, such as the tensor cores within Nvidia's GPUs[23] and Google's tensor processing unit (TPU), are designed to optimize spatial architectures that reduce the DRAM access and streamlined to use local register files [24]. However, the energy consumption in memory access in digital accelerators (˜pJ/MAC) is still one order of magnitude higher than arithmetic operations [22].

Analog electronics devices, such as memristor, are being considered as promising candidates to replace the digital accelerators [6]. Analog computing takes advantage of natural physical processes for array multiplications and summations, and therefore requires far fewer memory accesses in matrix calculation. It has been estimated that analog paradigm can reduce power consumption by ˜3 orders of magnitude psi. However, due to its lower precision and limited dynamic range, analog computing has thus been considered only in applications that are robust against device artifacts, such as neural networks [26].

### 1.2. Iterative Solver and Photonic Implementation

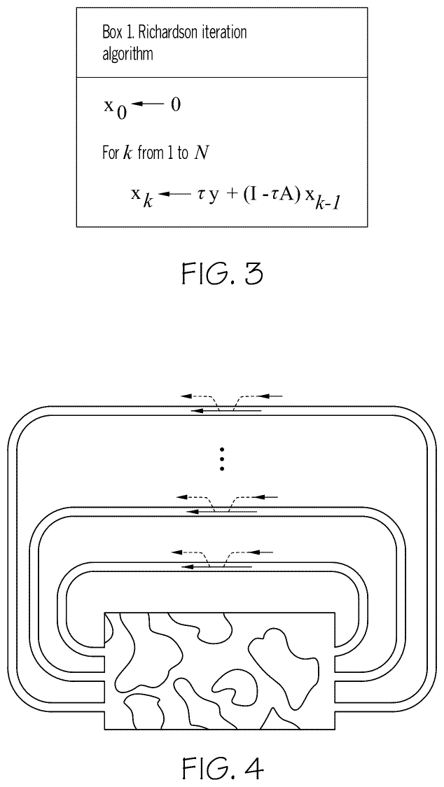

Broadly speaking, iterative method calculates a sequence of improving approximate solutions at each iteration and has a wide range of applications in solving systems of equations and optimization problems. It is one of the most common numerical methods in solving large-scale linear equations, where directly calculating the inverse is computationally expensive. Without loss of generality, the present invention, in one example, uses the simple Richardson iteration, shown in FIG. 3, in solving linear or near-linear system y=Ax. The simplicity and broad range of applications of Richardson iteration have attracted many optical implementations, where the matrix (I−τA) is encoded in optical structures (memory), such as holograms in the 90s [27], fiber couplers [28], and meta-materials in a more recent work [8]. Although the concept of iterative solver is described, the use of parallel computing techniques can be applied as well, in which several processors simultaneously execute multiple, smaller calculations broken down from an overall larger, complex problem.

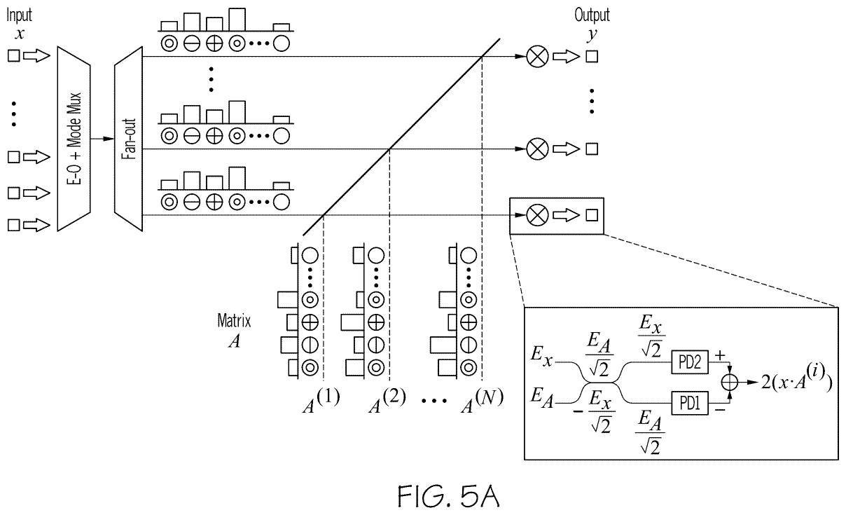

FIG. 4 replicates the scheme in [8], where the vector y are injected into the recurrent optical loops, and the iterative processes are carried out through multiple passes of the meta-material structures (matrix multiplication) and interferences with the injected field (vector summation). The solution is coupled out as a steady state is reached. Since the passive structure has low loss and small footprint, the photonics system has a high energy efficiency and fast response time [29]. However, there are two major disadvantages in such systems: 1) low computing precision limited by the photonic structures and 2) and limited reconfigurability for both the system (A) and other parameters (e.g. τ). These systems also does not have any management of analog computing error in the iterative processes, therefore unable to perform high precision computing tasks.

### 1.3. Photonics Matrix Accelerator Based on Mode Coherent Mixing

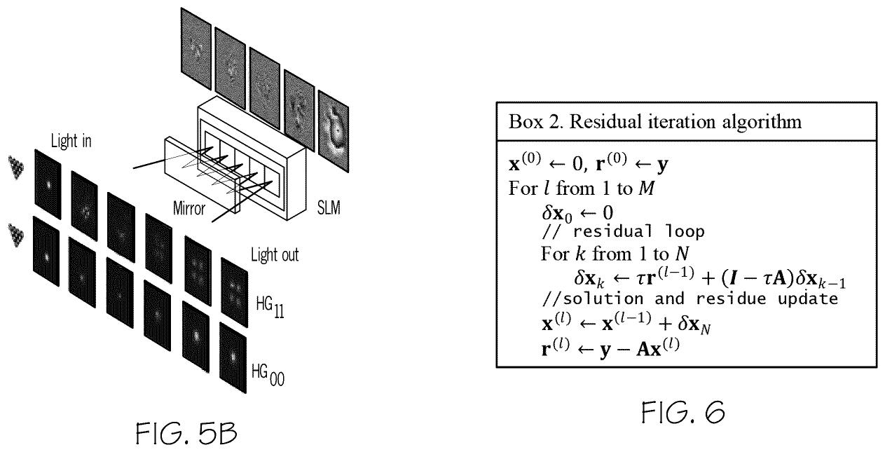

Previously, the inventors have invented a photonic matrix accelerator (PMA) that performs matrix-vector multiplications through coherent mixing, shown in FIG. 5A. Specifically, the multiplication between an input vector x and a row vector of the matrix A^{(k)} can be performed by element-wise coherent optical mixing between a spatial mode-division multiplexed (MDM) signal and a MDM local oscillator (LO). The accumulation can be performed by multimode photodetection and low-pass filtering, which is equivalent to integration. Here in this example a multi-plane light conversion (MPLC) is used to perform MDM, shown in FIG. 5B. Originally MPLC was devised to perform arbitrary unitary transformation in quantum optical information processing [30], [31]. It has been proven that with sufficient cascaded phase plates and free-space propagations in between, arbitrary unitary transformation can be constructed.

Matrix-vector multiplication can then be accomplished by exploiting the parallelism of free space. The same operation can be realized by replacing spatial modes with wavelengths. In addition, each orthogonal degree of freedom of light will coherently mix independently.

The major advantage of the WDM/MDM PMA is scalability. Utilizing MDM alone, the inventor's matrix accelerator can be scaled to at least 300×300 [32]. Mode multiplexers have a wide operating wavelength range and are, therefore, WDM (wavelength-division multiplexing) compatible. The PMA can potentially scale matrix-vector multiplication to an unprecedented size by combining wavelength and mode into one hyper-dimension. With today's technology, 300 wavelengths with a channel spacing of 10 GHz in the C-band and 300 spatial modes would leading to a vector length of 90,000.

While maintaining the energy efficiency of analog photonic systems [33], PMA has the following advantages compared with photonic computing device that encodes the information in its structures:
Both operands of matrix multiplication can be adjusted, therefore the precision is not limited by the photonic structures/photonic memories. The fixed pattern error can be compensated.
Under the context of iterative solver, the PMA is reconfigurable, allowing the adjustment of iterative step size and the implementation of regularization.
In total, there are 5 degrees of freedom (wavelength, vector mode, and 3 dimensions of space) to select from in order to construct photonic matrix multiplications. This level of multiplexing across the degrees of freedom are difficult to achieve through integrated photonic circuit.

The advantage of creating a photonic iterative solver (PIS) based on a hybrid analog-photonic and digital-electronic computing platform is that 1) provides orders-of-magnitude larger scalability than digital processors, 2) is fast, energy efficient and 3) is programmable to correct device imperfection and break conventional precision limited by analog devices. Different form the previous attempts in creating all-optical digital computers, the proposed platform does not perform bit-level logical operation but creates an iterative solver based analog photonic matrix accelerator that easily interfaces with digital electronics. Based on this platform, we will develop functional modules and computational methods to solve a wide range of science and engineering problems.

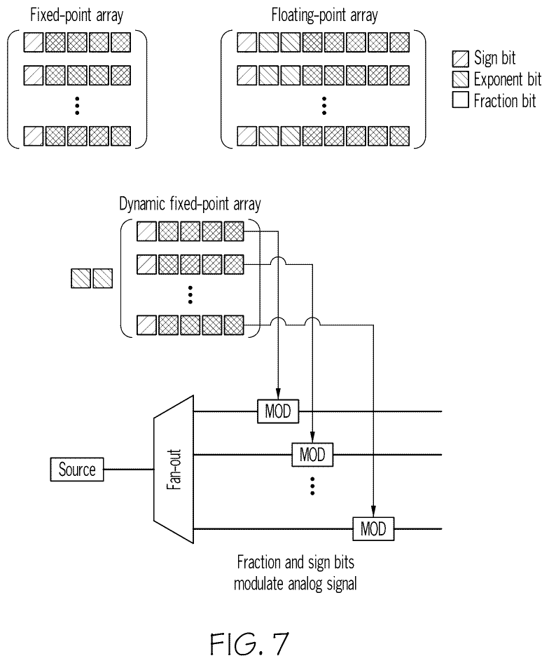

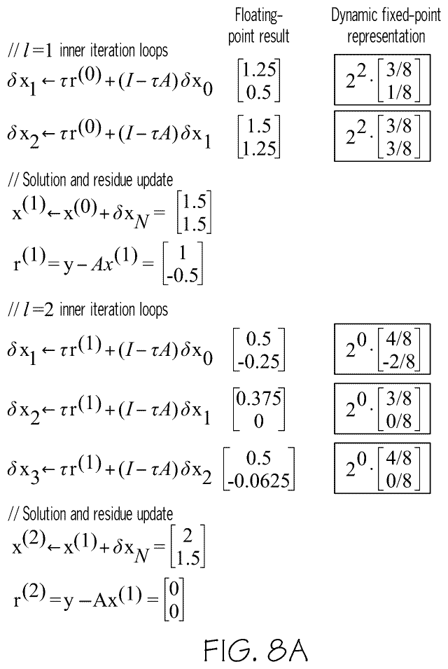

The numerical analysis of PIS is established using dynamic fixed-point (DFP) array. DFP array is a data structure that stores data in a format that combines the fixed-point and floating-point representations [34], as shown in FIG. 7. Each element of an DFP array is stored in fixed-point format and the whole array shares the same exponent bits. DFP format has a resurgence due to the recent interest in low-bit width neural networks [35]. The similar concept has also been explored in analog computing, termed as analog floating number [36]. Both works recognized the importance of dynamic range in many applications, and the range among the elements is often similar.

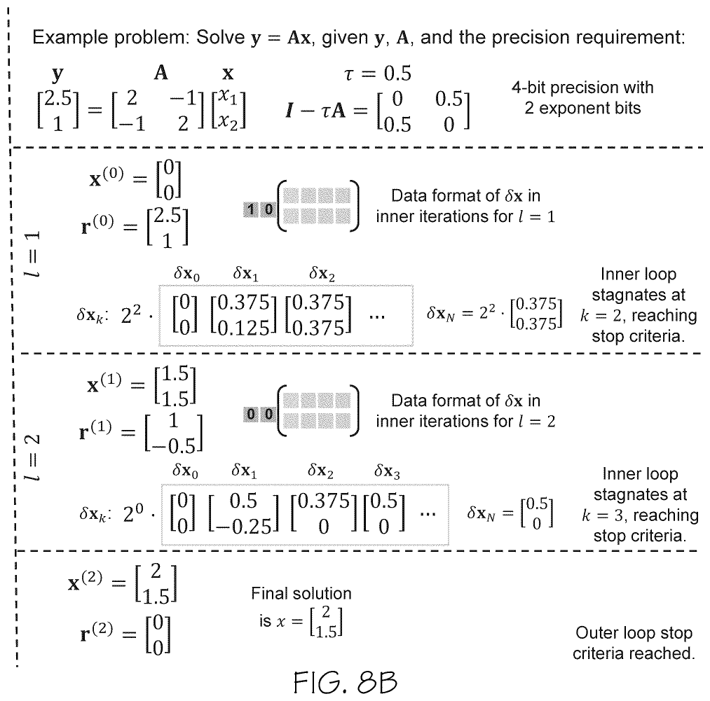

The analog computing errors can stagnate Richardson iteration. However, if the error is in a relative sense, i.e. the error is proportional to the magnitude of the operands, then by scaling down the magnitude, the iteration can further improve the solution accuracy. This technique was reported in the 90s and recently implemented in mixed-signal integrated circuit [38], yet the convergence property is unknown and these prior art systems do not support large-scale parallelization. Here, the present invention in this example discloses this technique with residual iteration algorithm shown in FIG. 6. The inner residual iteration loop is almost the same as Richardson iteration, but instead of direct generate solution series {xₖ} it generates the residue of the solution {δxₖ}. Since the residue r becomes less after each residual iteration loop, by digitally adjusting the exponent of solution residue ox and r. Solution with high precision x^{(l)} can be calculated. FIG. 8A and FIG. 8B illustrates this process in solving a two-variable linear system, where the solution residue δx and residue r are expressed in DFP format with 2 exponent bits, 4 fraction bits, and 1 sign bit. The residue loop computation has an equivalent precision of 4 bit. By adjusting the exponents of δx and r, the correct solution is reached with two updates (l=2). The residual loop can be efficiently carried out by the PIS and the update steps are performed on a digital computer to control the precision. Since the number of residue updates is only 1/N of that of the inner residual loop, the digital computing adds little computing overhead. Theorem 2 is proved, as shown below, which gives the error of residual iteration.

The invention can also be used to solve ill-conditioned linear systems. The common practice is to insert regularization steps within each iteration to enforce constraints to the solution. One computationally cost-effective way to impose the constraints is through thresholding, which can be simply implemented under the context of DFP exponent adjustment, shown in Box 3. This modified solver is a two-step iteration, in which the first step moves along the gradient of the measurement discrepancy term. The second step minimizes the projection of the intermediate solution, u, on the regularization domain[48], [49]. The matrix W represents the projection to the regularization domain, such as wavelet[50] and total-variation[51]. Adjusting the exponents of the DFP result is equivalent to range thresholding.

### Example of Photonic Analog Computing System

### 2.1 Single-Clock Cycle 3 by 3 Matrix-Vector Multiplication Based on Mode Division Multiplexing (MDM)

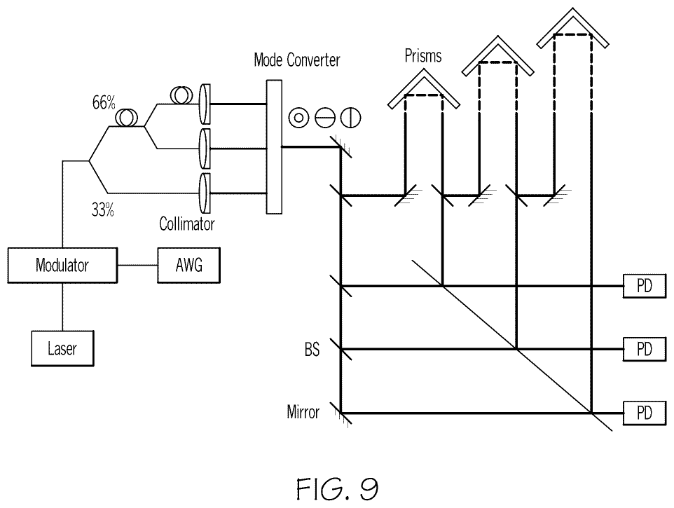

In one example, the present invention has demonstrated multiplication of a 3×3 matrix and a 3×1 vector based on mode division multiplexing. In total, there are 15 time-dependent variables need to be monitored: 3 input vector elements, 9 matrix elements and 3 output vector elements. Brute-force implementation would have required 12 transmitters, 3 receivers, and 15 scopes. In order to perform the matrix-vector multiplication in single clock cycle with limited resources, the experiment was implemented as shown in FIG. 9, in which only 1 transmitter, 1 MPLC mode multiplexer [39]-[41], and 3 multimode (MM) free-space unbalanced photodetectors are used.

All streams representing the input vector elements and matrix elements are generated from the same modulator with different amount of delay. After the laser passed through the modulator, it was split into three single mode fibers. The time delay between adjacent fiber equals one symbol period of the arbitrary waveform generator (AWG). The MPLC converts each single mode into corresponding Hermite Gaussian (HG) modes, which was then split into the reference and sample arms. The optical path length difference between the two arms is adjusted, so that the corresponding row of the matrix and the input vector are coherently super-imposed and accumulated by the free-space photodetectors.

### 2.2 Batch Matrix Multiplication

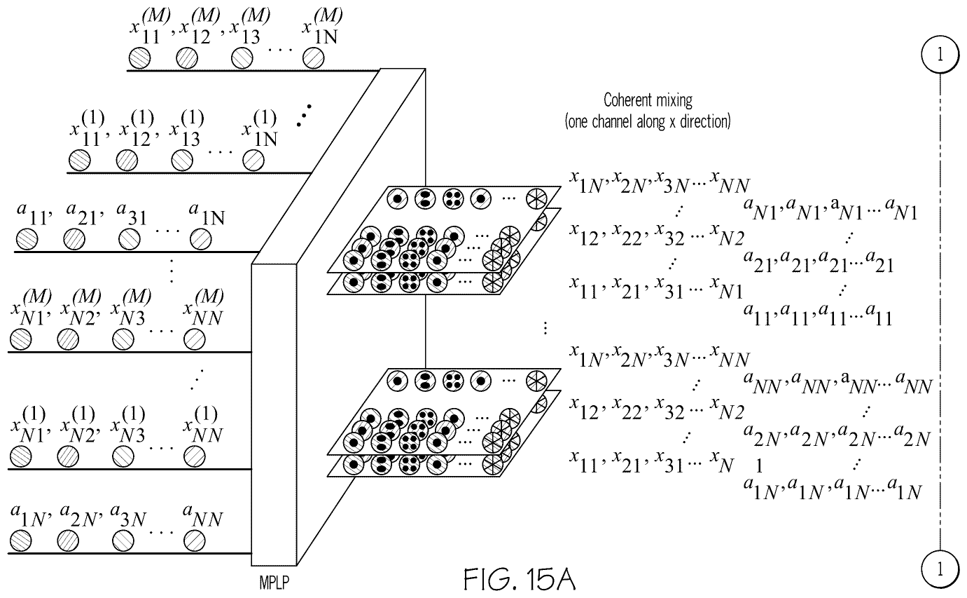

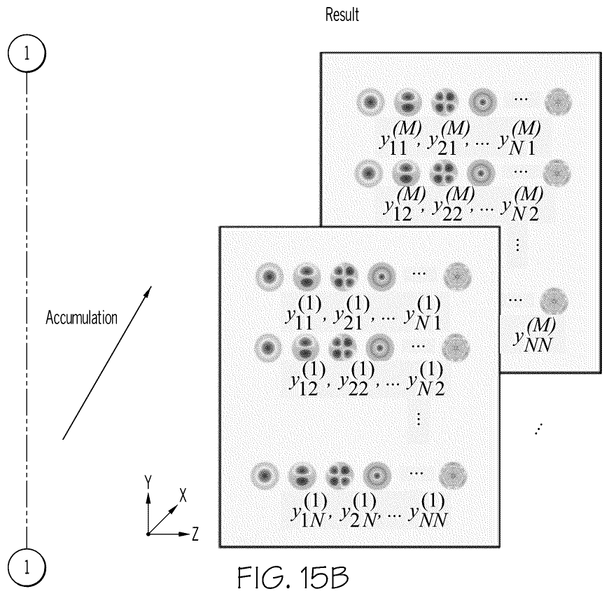

In this task, building a batch matrix-matrix multiplication system combining WDM and MDM as a building block of PIS is the focus. The schematics of batch dense matrix multiplication is illustrated in FIG. 15, where individual rows of the input matrix X^{(m)} are encoded in spatial dimension y, and the elements of each row are encoded in wavelength. In total there are M matrices in the batch, distributed in spatial dimension x. The columns of the system matrix A are encoded in y dimension and the column elements are encoded in wavelength. For matrix X^{(m)}, a multi-plane light processing (MPLP) is used to convert each row vector to its corresponding Hermite Gaussian (HG) mode and fan-out to N channels along the y dimension; for matrix A, MPLP duplicates the column vectors in mode dimension and matches the channels of matrix X^{(m)} in y dimension. The single matrix-matrix multiplication result is obtained from the accumulation along the wavelength dimension. An MPLP will be designed for 16 modes processing. For prototype, this example will start from 3×3 matrix-matrix multiplication with a batch number M=3 and proceeds to 8×8 with a batch number M=5. An 8-channel WDM distributed feedback laser diode module will be employed in the experiment. To reduce the number of modulators, delay-lines are used in the setup similar to that of FIG. 9. With a modulation frequency at 10 GHz, the system can reach a peak performance of 50 tera operations per second (TOPS).

It is worth noting that matrix multiplication of larger size can be carried out through block matrix multiplications. Furthermore, the parallelization is not confined to matrix-matrix multiplication; it can be further extended to high-dimensional tensor (with dimension>2) multiplication by exploiting all degrees of freedom of light field.

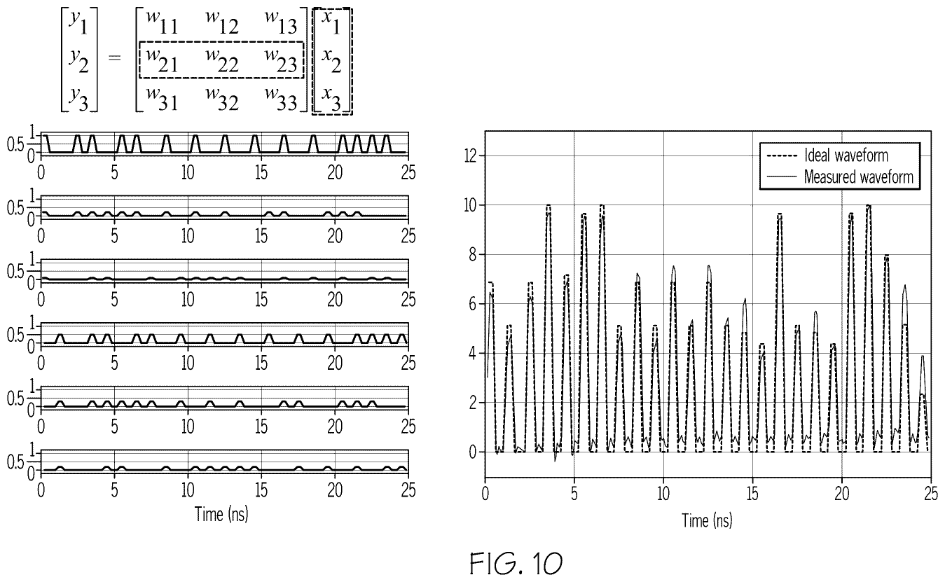

FIG. 10 illustrates the timing diagrams that generate the output of Channel 2. With all 3 detectors, 18 MACs could be carried out in a single clock cycle. Though this setup only allows positive-valued output, the preliminary experiments have demonstrated the feasibility of matrix-vector multiplication based on MDM. Balanced detection could enable multiplication with negative numbers and effectively compensate the bias. The results indicate that a precision equivalent or better than 6-bit is achievable for small-scale photonic matrix multiplications.

### 2.3 Convolution Through MPLP

Differentiation can be numerically carried out through convolution with finite difference kernels on discrete domains. One of the most common implementations of convolution on digital processors is through general matrix multiplication (GEMM) [56], which convert convolution to a matrix and vector multiplication between the input matrix and a column vector representing the kernel. However, GEMM-based convolution is sub-optimal in terms of energy efficiency for photonic implementation. The matrix constructed from the input vector contains multiple duplications of the input element, which requires excessive EO modulations, imposing a higher energy budget than using a passive fan-out device. Fast convolution algorithms have been explored on digital processors, including Fourier transform, Winograd transform, and Cook-Toom transform method [57]-[59]. Particularly, lens-based Fourier transform convolution has been long-established in optical community [60]. Essentially, these fast algorithms exploit domain transformation to reduces the number of multiplications required for convolution. Since the transformation-based convolution algorithms require only the modulation of the input and the kernel, and the transform can be performed by MPLP, it is therefore suitable for optical implementation.

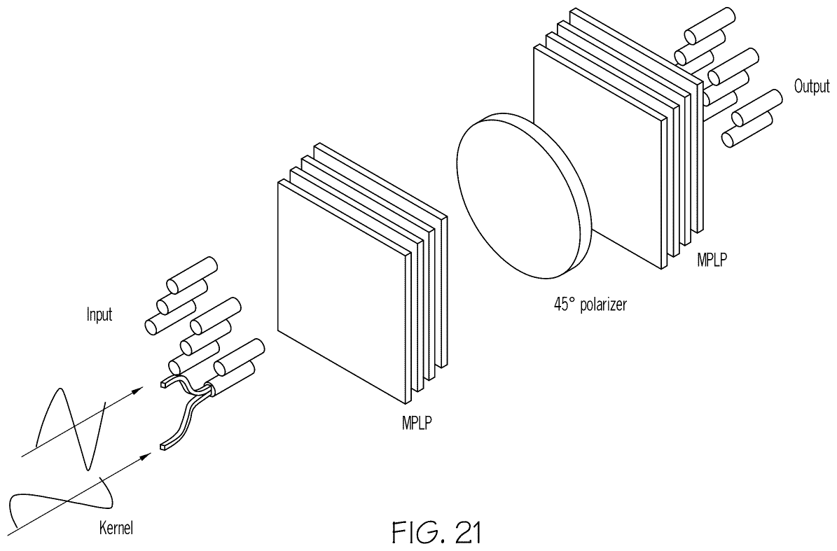

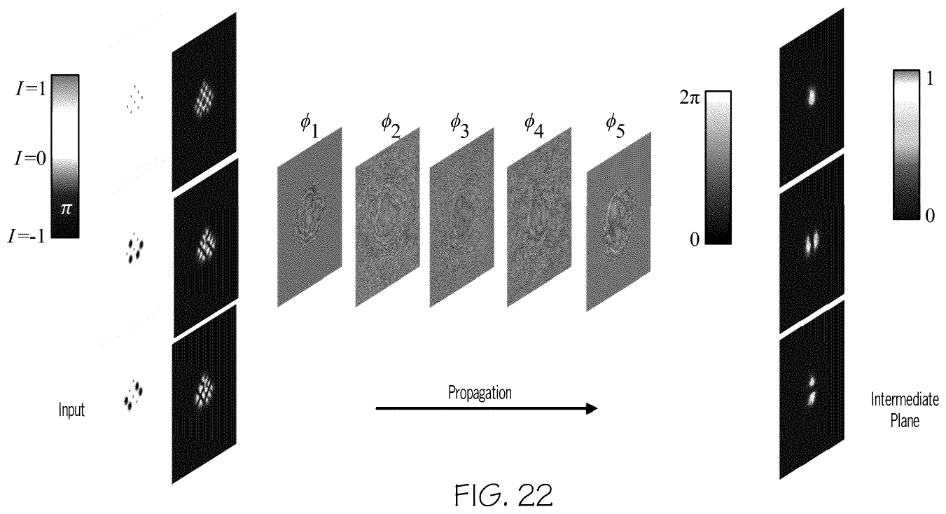

FIG. 21 and FIG. 22 depicts one possible implementation.

The input and kernels are modulated in orthogonal polarization states and feed into a specific location at the input plane. The first set of MPLP performs the domain transformation, and a 45° polarization plate allows the coherent mixing of the corresponding spatial modes. The second set of MPLP convert the mixed spatial modes to the output detection plane. Different from conventional Fourier-filtering system, the accuracy and the speed of the proposed implementation does not rely on the SLM-device on the Fourier plane. The MPLP design is flexible to accommodate unitary transformations. FIG. 22 illustrated our example design of discrete cosine transform (DCT) of the input. MPLP convolution for 1D supporting kernel size of 5 is first built and progresses to system that supports 2D kernel of size 5×5 .

### Example of Applications in Solving Equations

### 3.1 Solving High-Dimensional Linear Equations

Inverse problems are ubiquitous in imaging, and many imaging systems are or can be approximated as linear systems, such as compressive photography, computed tomography. The major advantage of the proposed PIS is its scalability. Mode multiplexers have a wide operating wavelength range and are, therefore, WDM compatible. In this task, WDM and MDM are combined to realize batch matrix multiplication and construct a high-dimensional linear system solver.

### 3.1.1 Matrix Inversion Using Fixed-Point Iterative Solver

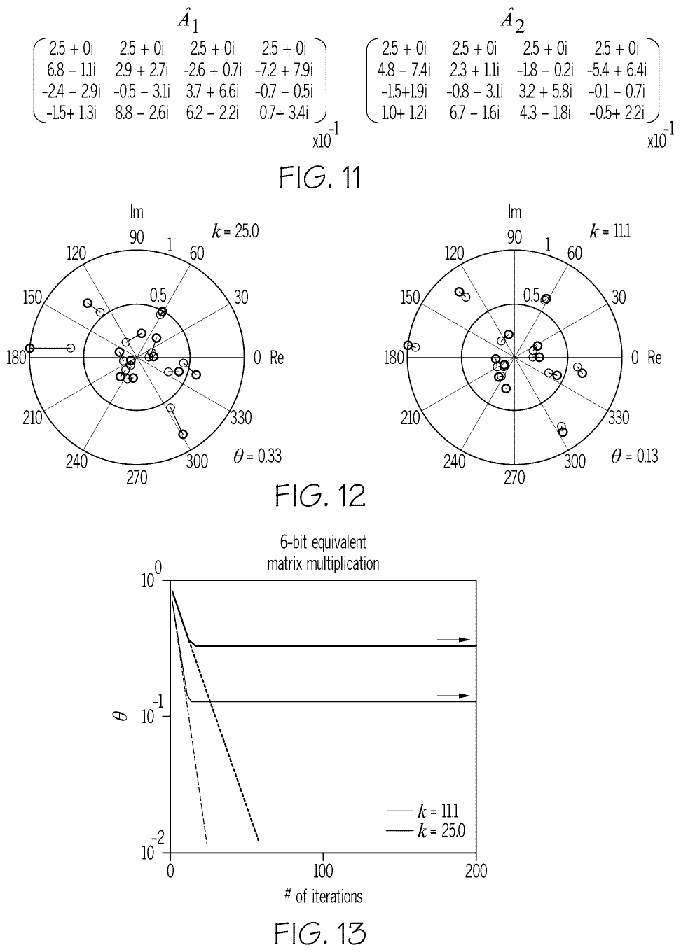

In general, calculating the inverse of a non-degenerate, N×N matrix is equivalent to simultaneously solving N linear equations (i.e. AX=I), which can be carried out by Richardson iteration. To verify Theorem 1, the inversion of two perturbed discrete Fourier transform (DFT) matrices using Richardson iteration is numerically calculated. In these examples, two matrices, A₁ and A₂, are constructed based on a 4×4 DFT matrix A₀ by applying different linear scaling factors to its eigenvalues. The condition numbers κ of A₁ and A₂ are 25.0 and 11.1, respectively. To iteratively inverse an N×N complex-valued matrix with real-valued matrix multiplications, it is expressed as a 2N×2N matrix in the form of

$$[ \begin{matrix}{A}_{real} & - {A}_{imag} \\ {A}_{imag} & {A}_{real}\end{matrix} ] ,$$

where Aᵣₑₐₗ and A_{imag} are the real and imaginary part of the matrix, respectively. In this example 6-bit fixed-point iterations (η=2⁻⁵) is used in the numerical calculation of the inversion. The results are compared with the direct inverse A calculated with LU decomposition, shown in FIG. 11 and FIG. 12. The decay of the normalized errors, θ, with respect to the number of iterations are plotted in FIG. 13, exhibiting the same asymptotic decay rate before reaching the residual error, which is independent of the numerical precision η. The iterative inversions of A₁ and A₂ have decay rates of 0.079 and 2 0 0.17, respectively, matching the analytical asymptotic decay rates of 0.072 and 0.16. The residue errors of 6-bit iterations are 0.33 and 0.13 for the inversion of A₁ and A₂, respectively, also in consistent with the value of 0.40 and 0.16, the upper bounds of the residues predicted by the Theorem. The results demonstrated that the low-precision matrix multiplication maintains the same convergence rate of its floating-point counterpart, indicating that analog iterative solvers do not compromise computing speed. Arrows mark the predicted upper bound of the residue errors by Theorem 1
3.1.2 Computed Tomography Reconstruction Using Residual Iteration with DFP

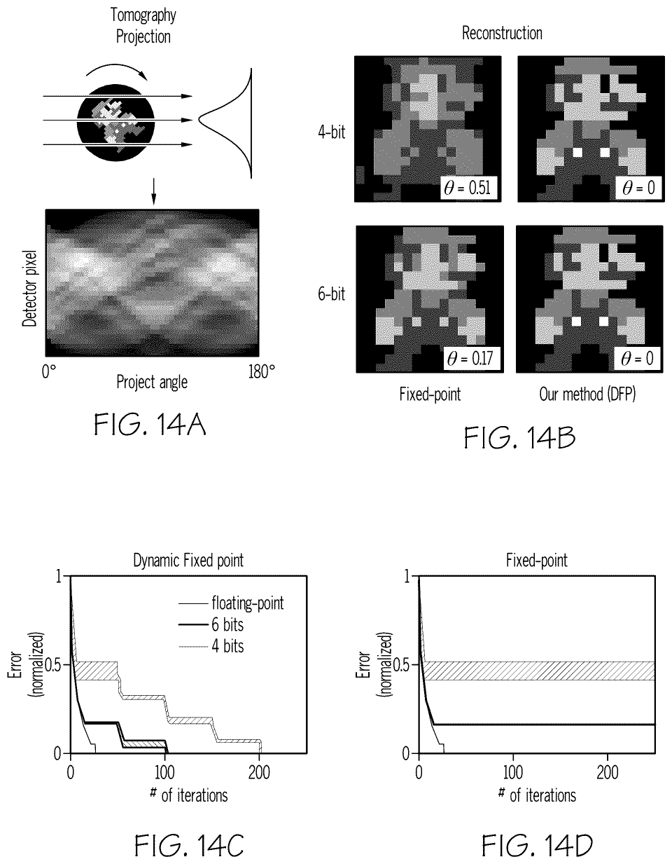

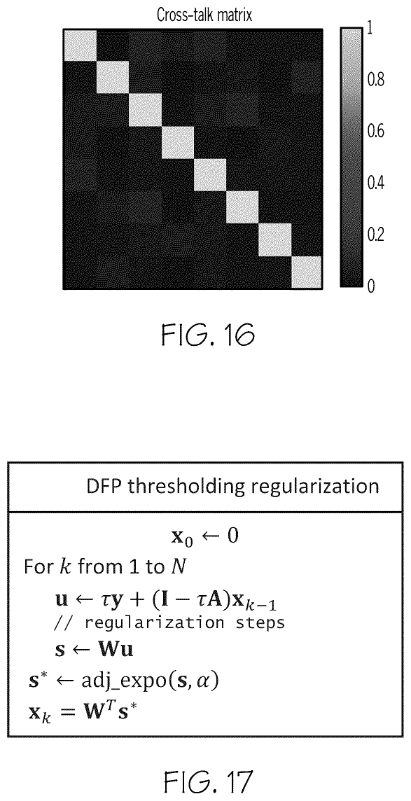

As shown above, fixed-point iteration leads to an error that is proportional to the precision of matrix multiplication. Indicated by Theorem 2, by using the residual iteration algorithm with the proposed dynamic fixed-point (DFP) format, the solution can reach precision levels beyond the limit of Richardson iteration. To verify this result, a reconstruction simulation of computed tomography (CT) is performed. In this example, the simulated object x* is a 16×16 “Super Mario” pixel art represented by a 4-bit fixed-point flattened array, whose range is [0, 1.0]. The forward model A is constructed from 60 projections at 3-degree spacing between 0 and 180°, each containing 32 pencil beams. During the residue iteration process, A is quantized to 6-bit fixed-point matrix, whose range is [0, 64]. The CT measurement y, shown in FIG. 16 is quantized to 10-bit fixed-point, whose range is [0, 512]. Residual iteration with bit widths of 4 and 6 (η=2⁻³ and 2⁻⁵) are used in image reconstruction shown in FIG. 14A. The exponent of the DFP are updated for a total of 5 corrections at an interval of 50 iterations. The residual errors of 4-, and 6-bit fixed-point iterations are 0.51 and 0.17 respectively (FIG. 14B), which are approximately proportional to the numerical precision, η. FIG. 14C shows 4- and 6-bit dynamic fixed-point reconstructions. FIG. 14D shows the errors with respect to the number of iterations. The error has a decay rate γ=0.11, reflecting the condition number 10¹˜10² of the forward model. Both 4- and 6-bit residue iterations reduce the errors below the quantization level of the object within 5 exponent adjustments. This suggests that dynamic fixed-point iterations can supersede floating-point iterations for better computation efficiency while maintaining the precision of the results.

### 3.1.3 High-Dimensional Tomography Reconstruction

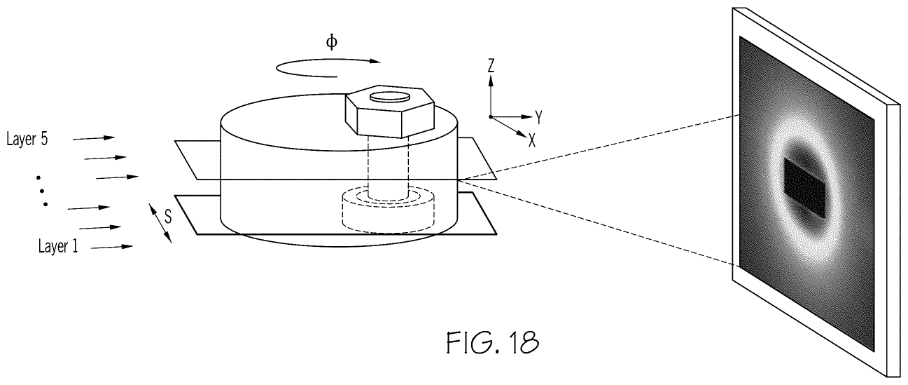

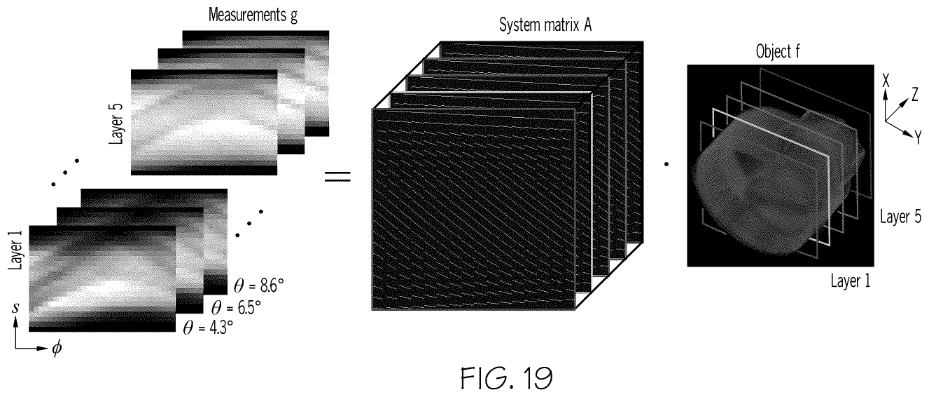

The reconstruction of a high-dimensional linear system—volumetric x-ray diffraction tomography (XDT) can be computed by the hybrid system. XDT measures the sinogram of x-ray diffraction pattern, g(s, ϕ; θ, z), at different angle θ and sample layer, z, and the goal is to reconstruct 3D location dependent profile in reciprocal space f (x, y, z, q). FIG. 18 shows the image formation process of volumetric XDT. The XDT imagery contains richer material composition information than conventional attenuation based computed tomography [52], providing at least 50% higher accuracy in material classification [53]. The PI's group has extensive experience in XDT reconstruction and data acquisition. The system matrix of volumetric XDT can be constructed from the weights in XDT ray-tracing model [54]. Since each x-ray beam only interacts with a small number of voxels, the matrix A is sparse, as shown in FIG. 19. Further acceleration of the calculation is possible.

The data for reconstruction in this task has been acquired by the PI's group. The measurement was digitized in 8-bit. The measurement datacube has 16 diffraction angles, from 16×16 object cross-section in the 5 layers. As a reference point, the reconstruction routine written on a computer with Xenon E5-2660 CPU (20 cores, 2.2 GHz) took ˜5 minutes. The whole batch forward process can be divided into ˜104 8×8-matrix multiplications. A clock frequency at 1 GHz can theoretically finish 103 iterations within 2 milliseconds without counting the latency. If adding in the overhead time of the non-matrix operations and data-transfer, processing time on the order of 10 seconds is feasible.

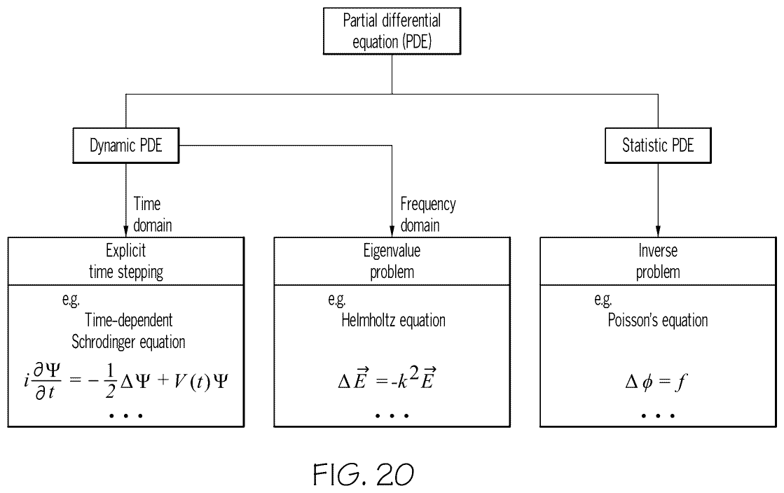

Numerical solvers of partial differential equations (PDEs) apply finite difference method to approximate the differential operators over discretized spatial and temporal grids, converting PDEs to a system of equations. The common approaches of numerically solving PDEs are shown in FIG. 20. Static PDEs are equivalent to solving linear systems [55]. For dynamic PDEs, if all the coefficients are time-independent, the spatial dimensions can be separated, and the PDE can be formulated into the eigenvalue problems. In this example will focus on solving the PDEs is this category using the proposed PIS.

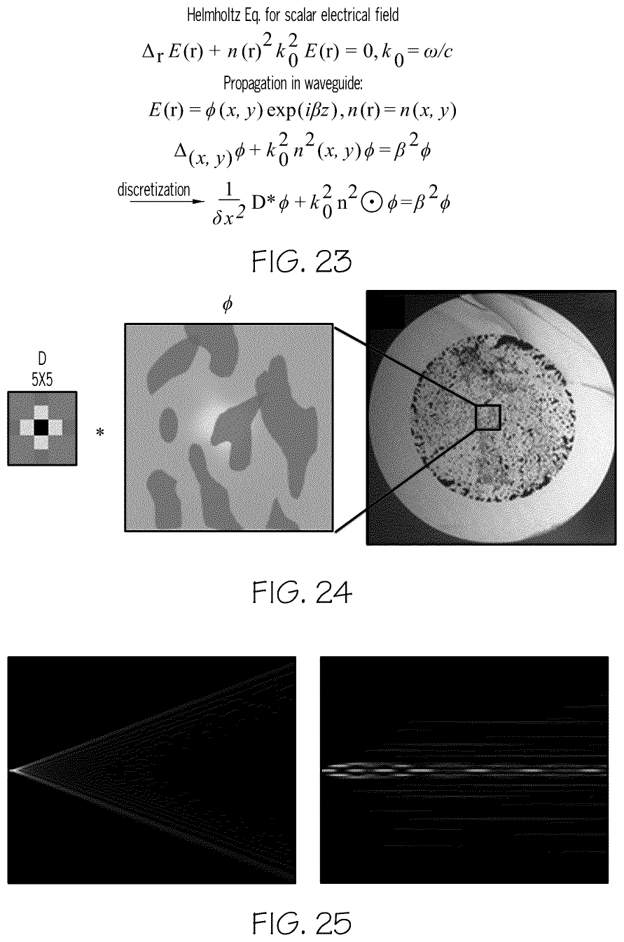

### 3.2 Solving Helmholtz Equation in Disordered Fiber Bundle (Transverse Anderson Localization) Shown in FIG. 23.

At the College of Optics and Photonics at the University of Central Florida (CREOL), with the in-house fiber manufacturing facilities, the inventors have pioneered in design and fabrication of random fibers supporting the transverse Anderson localization (TAL). Anderson localization is the absence of wave diffusion when propagating in highly disordered scattering media [61]. The present invention has demonstrated endoscopic imaging using TAL fibers, which shows imaging quality superior to commercial coherent fiber bundles [62]. In this task, a Helmholtz equation is solved using the PIS.

The solutions to Helmholtz equation are the eigenmodes supported in a photonics structure. For scalar electrical field propagating along the z direction in a waveguide, E(r)=ϕ(x, y) exp(iβz) can be assumed and Helmholtz equation ΔᵣE(r)+n(r)²k₀²E(r)=0 is reduced to an eigenvalue problem on the discretized spatial grid with sampling step δx

$$\frac{1}{δ {x}^{2}} D * ϕ + {k}_{0}^{2} {n}^{2} ⊙ ϕ = {β}^{2} ϕ$$

Here ϕ is an N×N matrix representing the cross-sectional distribution of the electrical field; n is the 2D refractive index matrix of the cross-section of fiber bundle; the Laplacian becomes a 2D convolution between the discrete Laplacian kernel D and matrix ϕ;⊙ is element-wise product. By initializing the eigenvector solver with different propagation constants β<max(n)k₀, the corresponding field profiles of the eigenmodes can be found by recurrently solving the inverse problem (A−β²I)ϕₖ₊₁=ϕₖ/Cₖ, termed inverse power method (IPM)[63], where A consists of convolution with

$$\frac{1}{δ {x}^{2}} D$$

and element-wise multiplication with k₀²n². The division by the scalar Cₖ in IPM prevents the growth of the norm |ϕₖ|, and can be implemented with DFP exponent adjustment step.

The 2D Laplacian kernel with 4 th -order accuracy consists of 5×5 elements, shown in FIG. 24. We will use 2D MPLP convolution system with 6-bit tensors in the task. A 512×512 tensor ϕ would contain ˜10⁴ sub-convolutions of 5×5 tensors. A clock frequency at 1 GHz can perform all the sub-convolutions in 0.3 seconds. The eigenmodes are verified using the beam-

propagation method on a small-scale structure (FIG. 25), and transit to solving the eigenmodes in an Anderson localization fiber [65]. These eigenmode properties found from PIS, such as the size and wavelength dependences, will be useful for constructing model-based variational inference routine [66 ] to recover color images transported through Anderson localization fiber [67].

### 3.3 Iterative Gradient-Based Optimization

Iterative gradient-based optimization methods have a broad range of applications. For example, the popular backpropagation training algorithm in neural network is essentially an iterative gradient optimization, and the iterative solver of linear system can be treated as the error minimization in the least square sense. Many physical laws described by partial differential equations are derived from more fundamental principles (e.g. principle of least action). Since the proposed PIS can efficiently perform iterations with a large parameter space, in this task, an optimization process based on PIS is performed.

### 3.3.1. Ab Initio Ray-Tracing Engine

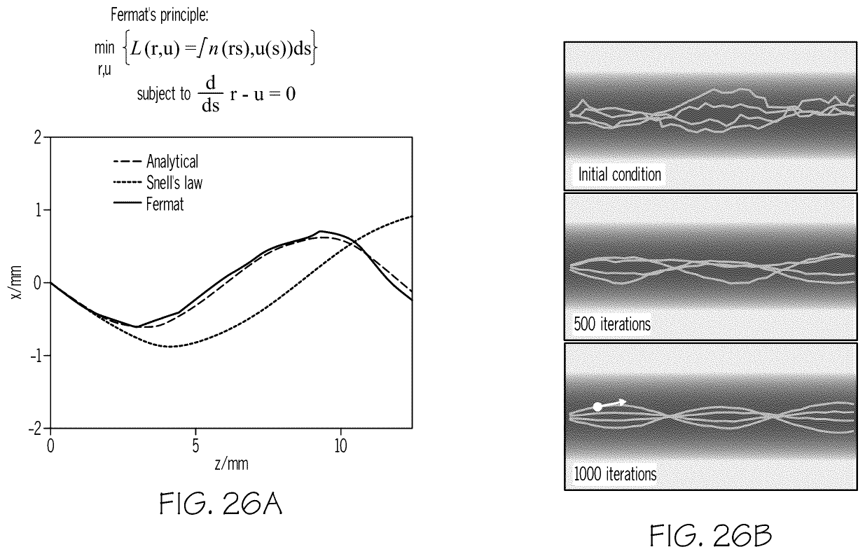

Specifically, a ray-tracing engine in a gradient-index field based on PIS will be developed. Ray-tracing engine generates visual images from 3D models, which plays a fundamental role in computer graphics. Rays transmitted through non-uniform media are routinely calculated using Snell's law. This sequential process will accumulate significant errors when the simulation is performed in a gradient-index field [68]. Instead, directly working with the underlying principle—Fermat's principle, which states that the feasible ray paths are the local extrema (maxima and minima) of optical path length. The ray tracing problem is thus transformed to a local optimization problem. Instead of setting the gradient to 0 (direct method), the PIS is used to iteratively find the extrema. FIG. 26A and FIG. 26B shows the ray tracing based on Fermat's principle in a gradient-index (GRIN) lens with a diameter of 8 mm, and a refractive index distribution along the radial dimension n(x)=\sqrt{n₀²−a²x²}, |x|<\sqrt{n₀²−1}/a, a=0.5 mm⁻¹. Each trace is discretized into a vector x, representing the radial positions along the discretized ray path s, with a grid size of Δs=0.5 mm. The pitch (period) calculated from Fermat's ray tracing is 11.6 mm, consistent with the analytical result 12.1 mm. As a comparison, using Snell's law on the same grid gives a pitch of 16.0 mm. The error is due to the finite grid size and accumulated over the increments. The spatial positions in ray tracing can be represented in DFP with 6-bit fixed-point tensors with exponents to represent the anisotropic sampling.

The first-principle optimization is computationally more expensive than direct method (Snell's law) on a general-purpose digital computer. However, the scalability of PIS could enable the update of large number of ray segments in one clock cycle. The gradient calculation can be implemented by a lookup table. With a clock frequency of 1 GHz, 1000 iterative updates on 100 ray traces can theoretically be completed in 30 milliseconds. Accurate ray tracing of refractive index field is an indispensable tool in study and simulation of imaging through turbulence. The technique of using PIS in gradient-based optimization method can be applied to a wider range of applications.

### High Level Flow Diagram

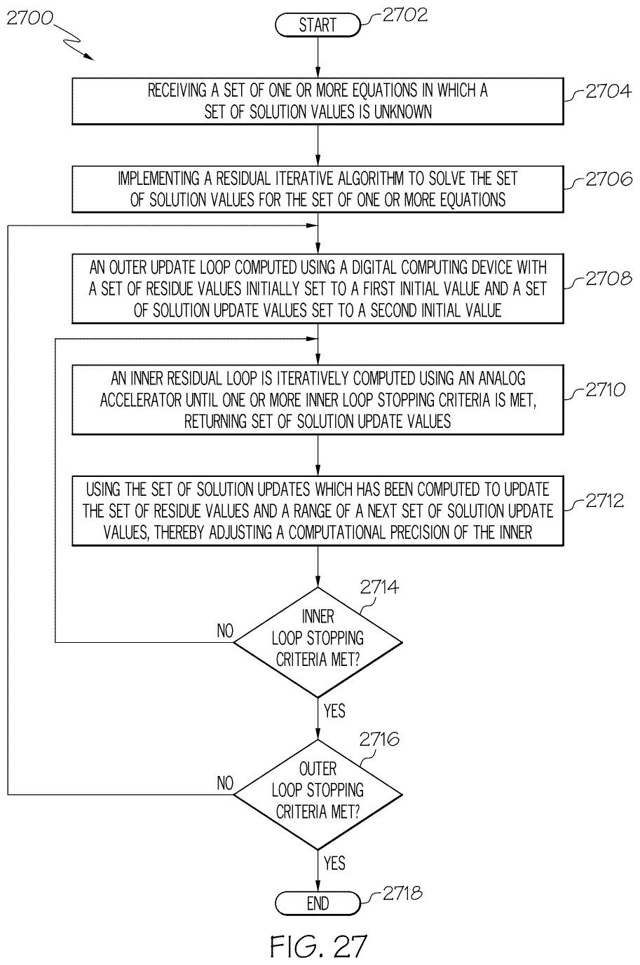

FIG. 27 is a high-level example overall flow 2700 of the process, as described in the preceding figures, according to one aspect of the present invention.

The process begins in step 2702 and immediately proceeds to step 2704. In step 2704, a set of one or more equations in which a set of solution values is unknown is received. The set one or more equations may include linear equations or a set of near linear equations. The process continues to step 2706. In step 2706, a residual iterative algorithm is implemented to solve the set of solution values for the set of one or more equations. The process continues to step 2708. In step 2708, the residual iterative algorithm includes an outer update loop computed using a digital computing device with a set of residue values initially set to a first initial value and a set of solution update values set to a second initial value. The process continues to step 2710. In step 2710, the residual iterative algorithm includes an inner residual loop, which is iteratively computed using an analog accelerator until one or more inner residual loop stopping criteria is met and returning set of solution update values. The process continues to step 2712. In step 2712, the set of solution updates are used which has been computed to update the set of residue values and a range of a next set of solution update values, thereby adjusting a computational precision of the inner residual loop. The process continues to step 2714. In step 2714, the steps the inner residual loop are repeated until one or more inner loop stopping criteria is met. If the inner residual loop stopping criteria is met the process continues to step 2716 and otherwise the process flow back to step 2710 as shown. In step 2716, a test is made if one or more outer loop stopping criteria is met. If the outer loop stopping criteria is met the process continues to step 2718 and ends and otherwise the process flow back to step 2708.

In one example, the inner residual loop and/or the outer update loop stopping criteria is one of time, a number of iterations, a threshold for a set of values that are calculated based on solution update values, a threshold for a set of values that are calculated based on residual values or a combination thereof. The inner residual loop may be computed in parallel and independently from other inner residual loop computations using analog parallel computational techniques.

In another example, the analog accelerator is one of photonic accelerator, a neuromorphic accelerator, a neuromemristive accelerator, a biochemical accelerator, a biomechanical accelerator, an analog AI accelerator, or a combination thereof. The analog accelerator may use coherent mixing in computing large scale linear computations, such as vector-vector, matrix-vector, matrix-matrix, or tensor-tensor multiplications. The analog accelerator may also use a degree of freedom in light to encode thereof is one of a wavelength, a spatial mode, a polarization, and a component of a wave vector, or a combination thereof. Still further, the analog accelerator may produce an analog signal which is converted to a fixed-point digital signal with an exponent bit to encode a range of the fixed-point digital signal. Finally, the range of the fixed-point digital signal may be determined by one of i) a current analog signal, ii) a calculation on a digital component of the fixed-point digital signal with a value from a previous iteration, or iii) a combination of both.

In another example, the set of residue values and other set of input values for the inner residual loop are updated with a deterministic calculation or a calculation including randomness. The residual iterative algorithm may solve an equation corresponding to an optimization problem.

In yet another example, the digital computing device adjusts a value of the range. The analog accelerator may use only a value from fixed-point bits and does not use a value from exponent bits. The digital computing device may produce a dynamic fixed-point digital signal which is converted to an analog signal that feeds back to the analog accelerator.

### Non-Limiting Examples

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without use of other features of the present invention. As such, the foregoing description should be considered as merely illustrative of the principles, teachings, examples, and exemplary embodiments of the present invention, and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

### INCORPORATED REFERENCES

The following publications are each incorporated by reference in their entirety:

Incorporated References Listed in the Information Disclosure
ADDIN Mendeley Bibliography CSL_BIBLIOGRAPHY [1] R. B. Alley, K. A. Emanuel, and F. Zhang, “Advances in weather prediction,” Science (80-.)., vol. 363, no. 6425, pp. 342-344, Jan. 2019, doi: 10.1126/science.aav7274.
[2] G. Hinton et al., “Deep Neural Networks for Acoustic Modeling in Speech Recognition: The Shared Views of Four Research Groups,” IEEE Signal Process. Mag., vol. 29, no. 6, pp. 82-97, Nov. 2012, doi: 10.1109/MSP.2012.2205597.
[3] K. He, X. Zhang, S. Ren, and J. Sun, “Identity mappings in deep residual networks,” Lect. Notes Comput. Sci. (including Subser. Lect. Notes Artif. Intell. Lect. Notes Bioinformatics), vol. 9908 LNCS, pp. 630-645, 2016, doi: 10.1007/978-3-319-46493-0_38.
[4] K. Simonyan and A. Zisserman, “Very Deep Convolutional Networks for Large-Scale Image Recognition,” pp. 1-14, 2014, doi: 10.1016/j.infsof.2008.09.005.
[5] S. W. Keckler, W. J. Dally, B. Khailany, M. Garland, and D. Glasco, “GPUs and the Future of Parallel Computing,” IEEE Micro, vol. 31, no. 5, pp. 7-17, Sep. 2011, doi: 10.1109/MM.2011.89.
[6] W. Haensch, T. Gokmen, and R. Puri, “The Next Generation of Deep Learning Hardware: Analog Computing,” Proc. IEEE, vol. 107, no. 1, pp. 108-122, Jan. 2019, doi: 10.1109/JPROC.2018.2871057.
[7] H. J. Caulfield and S. Dolev, “Why future supercomputing requires optics,” Nat. Photonics, vol. 4, no. 5, pp. 261-263, May 2010, doi: 10.1038/nphoton.2010.94.
[8] N. Mohammadi Estakhri, B. Edwards, and N. Engheta, “Inverse-designed metastructures that solve equations,” Science (80-.)., vol. 363, no. 6433, pp. 1333-1338, Mar. 2019, doi: 10.1126/science.aaw2498.
[9] D. Brunner, S. Reitzenstein, and I. Fischer, “All-optical neuromorphic computing in optical networks of semiconductor lasers,” 2016, doi: 10.1109/ICRC.2016.7738705.
[10] T. Deng, J. Robertson, and A. Hurtado, “Controlled Propagation of Spiking Dynamics in Vertical-Cavity Surface-Emitting Lasers: Towards Neuromorphic Photonic Networks,” IEEE J. Sel. Top. Quantum Electron., 2017, doi: 10.1109/JSTQE.2017.2685140.
[11] T. Ferreira de Lima, B. J. Shastri, A. N. Tait, M. A. Nahmias, and P. R. Prucnal, “Progress in neuromorphic photonics,” Nanophotonics, 2017, doi: 10.1515/nanoph-2016-0139.
[12] A. N. Tait et al., “Neuromorphic photonic networks using silicon photonic weight banks,” Sci. Rep., 2017, doi: 10.1038/s41598-017-07754-z.
[13] p H. T. Peng, M. A. Nahmias, T. F. De Lima, A. N. Tait, B. J. Shastri, and P. R. Prucnal, “Neuromorphic Photonic Integrated Circuits,” IEEE J. Sel. Top. Quantum Electron., 2018, doi: 10.1109/JSTQE.2018.2840448.
[14] J. K. George et al., “Neuromorphic photonics with electro-absorption modulators,” Opt. Express, vol. 27, no. 4, p. 5181, Feb. 2019, doi: 10.1364/OE.27.005181.
[15] K. Vandoorne et al., “Toward optical signal processing using Photonic Reservoir Computing,” Opt. Express, vol. 16, no. 15, p. 11182, Jul. 2008, doi: 10.1364/OE.16.011182.
[16] F. Duport, B. Schneider, A. Smerieri, M. Haelterman, and S. Massar, “All-optical reservoir computing,” Opt. Express, 2012, doi: 10.1364/oe.20.022783.
[17] L. Pesquera et al., “Photonic information processing beyond Turing: an optoelectronic implementation of reservoir computing,” Opt. Express, vol. 20, no. 3, p. 3241, 2012, doi: 10.1364/oe.20.003241.
[18] Y. Paquot et al., “Optoelectronic reservoir computing,” Sci. Rep., 2012, doi: 10.1038/srep00287.
[19] A. Dejonckheere et al., “All-optical reservoir computer based on saturation of absorption,” Opt. Express, 2014, doi: 10.1364/oe.22.010868.
[20] L. Larger, A. Baylón-Fuentes, R. Martinenghi, V. S. Udaltsov, Y. K. Chembo, and M. Jacquot, “High-speed photonic reservoir computing using a time-delay-based architecture: Million words per second classification,” Phys. Rev. X, 2017, doi: 10.1103/PhysRevX.7.011015.
[21] A. Katumba, J. Heyvaert, B. Schneider, S. Uvin, J. Dambre, and P. Bienstman, “Low-Loss Photonic Reservoir Computing with Multimode Photonic Integrated Circuits,” Sci. Rep., 2018, doi: 10.1038/s41598-018-21011-x.
[22] M. Horowitz, “1.1 Computing's energy problem (and what we can do about it),” in 2014 IEEE International Solid-State Circuits Conference Digest of Technical Papers (ISSCC), Feb. 2014, pp. 10-14, doi: 10.1109/ISSCC.2014.6757323.
[23] S. Markidis, S. W. Der Chien, E. Laure, I. B. Peng, and J. S. Vetter, “NVIDIA tensor core programmability, performance & precision,” Proc.—2018 IEEE 32nd Int. Parallel Distrib. Process. Symp. Work. IPDPSW 2018, pp. 522-531, 2018, doi: 10.1109/IPDPSW.2018.00091.
[24] V. Sze, Y. Chen, T. Yang, and J. S. Emer, “Efficient Processing of Deep Neural Networks: A Tutorial and Survey,” Proc. IEEE, vol. 105, no. 12, pp. 2295-2329, 2017, doi: 10.1109/JPROC.2017.2761740.
[25] T. Gokmen and Y. Vlasov, “Acceleration of Deep Neural Network Training with Resistive Cross-Point Devices: Design Considerations,” Front. Neurosci., vol. 10, Jul. 2016, doi: 10.3389/fnins.2016.00333.
[26] S. Ambrogio et al., “Equivalent-accuracy accelerated neural-network training using analogue memory,” Nature, vol. 558, no. 7708, pp. 60-67, Jun. 2018, doi: 10.1038/s41586-018-0180-5.
[27] H. Rajbenbach, Y. Fainman, and S. H. Lee, “Optical implementation of an iterative algorithm for matrix inversion,” Appl. Opt., vol. 26, no. 6, p. 1024, Mar. 1987, doi: 10.1364/AO.26.001024.
[28] K. Wu, C. Soci, P. P. Shum, and N. I. Zheludev, “Computing matrix inversion with optical networks,” Opt. Express, vol. 22, no. 1, p. 295, 2014, doi: 10.1364/oe.22.000295.
[29] D. A. B. Miller, “Attojoule Optoelectronics for Low-Energy Information Processing and Communications,” J. Light. Technol., vol. 35, no. 3, pp. 346-396, Feb. 2017, doi: 10.1109/JLT.2017.2647779.
[30] Z. I. Borevich and S. L. Krupetskii, “Subgroups of the unitary group that contain the group of diagonal matrices,” J. Sov. Math., 1981, doi: 10.1007/BF01465451.
[31] J.-F. Morizur et al., “Programmable unitary spatial mode manipulation,” J. Opt. Soc. Am. A, vol. 27, no. 11, p. 2524, Nov. 2010, doi: 10.1364/JOSAA.27.002524.
[32] N. K. Fontaine, R. Ryf, H. Chen, D. T. Neilson, K. Kim, and J. Carpenter, “Laguerre-Gaussian mode sorter,” Nat. Commun., vol. 10, no. 1, p. 1865, Dec. 2019, doi: 10.103 8/s41467-019-09840-4.
[33] R. Hamerly, L. Bernstein, A. Sludds, M. Soljačić, and D. Englund, “Large-Scale Optical Neural Networks Based on Photoelectric Multiplication,” Phys. Rev. X, vol. 9, no. 2, pp. 1-12, 2019, doi: 10.1103/physrevx.9.021032.
[34] J.-F. Wang, T.-W. Kuan, J.-C. Wang, and T.-W. Sun, “Dynamic Fixed-Point Arithmetic Design of Embedded SVM-Based Speaker Identification System,” 2010, pp. 524-531.
[35] M. Courbariaux, Y. Bengio, and J.-P. David, “Training deep neural networks with low precision multiplications,” arXiv Prepr. arXiv1412.7024, Dec. 2014, [Online]. Available: http://arxiv.org/abs/1412.7024.
[36] E. M. Blumenkrantz, “The analog floating point technique,” in 1995 IEEE Symposium on Low Power Electronics. Digest of Technical Papers, 2002, pp. 72-73, doi: 10.1109/LPE.1995.482469.
[37] C. C. Douglas, J. Mandel, and W. L. Miranker, “Fast Hybrid Solution of Algebraic Systems,” SIAM J. Sci. Stat. Comput., vol. 11, no. 6, pp. 1073-1086, Nov. 1990, doi: 10.1137/0911060.
[38] Y. Huang, N. Guo, M. Seok, Y. Tsividis, and S. Sethumadhavan, “Analog Computing in a Modern Context: A Linear Algebra Accelerator Case Study,” IEEE Micro, vol. 37, no. 3, pp. 30-38, 2017, doi: 10.1109/MM.2017.55.
[39] G. Labroille, B. Denolle, P. Jian, J. F. Morizur, P. Genevaux, and N. Treps, “Efficient and mode selective spatial mode multiplexer based on multi-plane light conversion,” 2014, doi: 10.1109/IPCon.2014.6995478.
[40] N. K. Fontaine, R. Ryf, H. Chen, D. T. Neilson, K. Kim, and J. Carpenter, “Scalable mode sorter supporting 210 Hermite-Gaussian modes,” in Optical Fiber Communication Conference Postdeadline Papers, 2018, p. Th4B.4, doi: 10.1364/OFC.2018.Th4B.4.
[41] S. Bade et al., “Fabrication and Characterization of a Mode-selective 45-Mode Spatial Multiplexer based on Multi-Plane Light Conversion,” in Optical Fiber Communication Conference Postdeadline Papers, 2018, p. Th4B.3, doi: 10.1364/OFC.2018.Th4B.3.
[42] D. Woods and T. J. Naughton, “Optical computing: Photonic neural networks,” Nature Physics, vol. 8, no. 4. Nature Publishing Group, pp. 257-259, 2012, doi: 10.1038/nphys2283.
[43] “Fujitsu 56GSa/s ADC.” https://www.fujitsu.com/downloads/MICRO/fma/pdf/56G_ADC_FactSheet.pdf.
[44] “Keysight.” https://www.keysight.com/en/pc-3048423/wideband-streaming-and-signal-processing-products.
[45] G. Labroille, B. Denolle, P. Jian, P. Genevaux, N. Treps, and J.-F. Morizur, “Efficient and mode selective spatial mode multiplexer based on multi-plane light conversion,” Opt. Express, vol. 22, no. 13, p. 15599, Jun. 2014, doi: 10.1364/OE.22.015599.
[46] J. F. Morizur, P. Jian, B. Denolle, O. Pinel, N. Barre, and G. Labroille, “Efficient and mode-selective spatial multiplexer based on multi-plane light conversion,” Opt. Express, vol. 22, no. 13, pp. 15599-15607, 2014, doi: 10.1364/oe.22.015599.
[47] S. Gupta, A. Agrawal, K. Gopalakrishnan, and P. Narayanan, “Deep Learning with Limited Numerical Precision,” 32nd Int. Conf. Mach. Learn. ICML 2015, vol. 3, pp. 1737-1746, Feb. 2015, [Online]. Available: http://arxiv.org/abs/1502.02551.
[48] Z. T. Harmany, R. F. Marcia, and R. M. Willett, “This is SPIRAL-TAP: Sparse Poisson Intensity Reconstruction ALgorithms—Theory and Practice,” IEEE Trans. Image Process., vol. 21, no. 3, pp. 1084-1096, Mar. 2012, doi: 10.1109/TIP.2011.2168410.
[49] Z. Zhu, H.-H. Huang, and S. Pang, “Photon Allocation Strategy in Region-of-Interest Tomographic Imaging,” IEEE Trans. Comput. Imaging, vol. 6, pp. 125-137, 2020, doi: 10.1109/TCI.2019.2922477.
[50] B. Zhang, J. M. Fadili, and J. L. Starck, “Wavelets, ridgelets, and curvelets for poisson noise removal,” IEEE Trans. Image Process., vol. 17, no. 7, pp. 1093-1108, 2008, doi: 10.1109/TIP.2008.924386.
[51] A. Beck and M. Teboulle, “Fast gradient-based algorithms for constrained total variation image denoising and deblurring problems,” IEEE Trans. Image Process., vol. 18, no. 11, pp. 2419-2434, 2009, doi: 10.1109/TIP.2009.2028250.
[52] Z. Zhu, R. A. Ellis, and S. Pang, “Coded cone-beam x-ray diffraction tomography with a low-brilliance tabletop source,” Optica, vol. 5, no. 6, p. 733, Jun. 2018, doi: 10.1364/OPTICA.5.000733.
[53] Z. Zhu, A. Katsevich, A. J. Kapadia, J. A. Greenberg, and S. Pang, “X-ray diffraction tomography with limited projection information,” Sci. Rep., vol. 8, no. 1, p. 522, Dec. 2018, doi: 10.1038/s41598-017-19089-w.
[54] J. Ulseth, Z. Zhu, Y. Sun, and S. Pang, “Accelerated x-ray diffraction (tensor) tomography simulation using OptiX GPU ray-tracing engine,” IEEE Trans. Nucl. Sci., vol. 66, no. 12, pp. 1-1, 2019, doi: 10.1109/tns.2019.2948796.
[55] R. M. M. Mattheij, S. W. Rienstra, and J. H. M. T. T. Boonkkamp, Partial differential equations: modeling, analysis, computation. SIAM, 2005.
[56] J. Ross et al., “Neural Network Processor,” US9710748, Aug. 2017.
[57] J. Chang, V. Sitzmann, X. Dun, W. Heidrich, and G. Wetzstein, “Hybrid optical-electronic convolutional neural networks with optimized diffractive optics for image classification,” Sci. Rep., vol. 8, no. 1, 2018, doi: 10.1038/s41598-018-30619-y.
[58] A. Lavin and S. Gray, “Fast Algorithms for Convolutional Neural Networks,” in Proceedings of the IEEE Computer Society Conference on Computer Vision and Pattern Recognition, 2016, vol. 2016-Decem, pp. 4013-4021, doi: 10.1109/CVPR.2016.435.
[59] Y. Wang and K. Parhi, “Explicit Cook-Toom algorithm for linear convolution,” in 2000 IEEE International Conference on Acoustics, Speech, and Signal Processing. Proceedings (Cat. No.00CH37100), 2000, vol. 6, pp. 3279-3282, doi: 10.1109/ICASSP.2000.860100.
[60] J. W. Goodman, Introduction to Fourier optics, 3rd ed. Roberts and Company Publishers, 2005.
[61] A. Mafi, “Transverse Anderson localization of light: a tutorial,” Adv. Opt. Photonics, vol. 7, no. 3, p. 459, Sep. 2015, doi: 10.1364/AOP.7.000459.
[62] J. Zhao et al., “Deep Learning Imaging through Fully-Flexible Glass-Air Disordered Fiber,” ACS Photonics, vol. 5, no. 10, pp. 3930-3935, Oct. 2018, doi: 10.1021/acsphotonics.8b00832.
[63] J. W. Demmel, Applied Numerical Linear Algebra. Society for Industrial and Applied Mathematics, 1997.
[64] G. R. Hadley, “Transparent Boundary Condition for the Beam Propagation Method,” IEEE J. Quantum Electron., vol. 28, no. 1, pp. 363-370, 1992, doi: 10.1109/3.119536.
[65] J. Zhao et al., “Image Transport Through Meter-Long Randomly Disordered Silica-Air Optical Fiber,” Sci. Rep., vol. 8, no. 1, p. 3065, Dec. 2018, doi: 10.1038/s41598-018-21480-0.
[66] Z. Zhu, Y. Sun, J. White, Z. Chang, and S. Pang, “Signal retrieval with measurement system knowledge using variational generative model,” arXiv Prepr. arXiv1909.04188, 2019.
[67] J. Zhao et al., “Deep-Learning-Based Imaging through Glass-Air Disordered Fiber with Transverse Anderson Localization,” in Conference on Lasers and Electro-Optics, 2018, vol. Part F94-C, p. STu3K.3, doi: 10.1364/CLEO_SI.2018.STu3K.3.
[68] H. Ohno, “Symplectic ray tracing based on Hamiltonian optics in gradient-index media,” J. Opt. Soc. Am. A, vol. 37, no. 3, p. 411, Mar. 2020, doi: 10.1364/JOSAA.378829.

1. A method of creating of hybrid analog and digital computational system, the method comprising:
receiving a set of one or more equations in which a set of solution values is unknown; and
implementing a residual iterative algorithm to solve the set of solution values for the set of one or more equations, the residual iterative algorithm includes an outer update loop computed using a digital computing device with a set of residue values initially set to a first initial value and a set of solution update values set to a second initial value,
a) an inner residual loop is iteratively computed using an analog accelerator until one or more inner residual loop stopping criteria is met, returning set of solution update values,
b) using the set of solution updates which has been computed to update the set of residue values and a range of a next set of solution update values, thereby adjusting a computational precision of the inner residual loop, and
c) repeating steps a through c until one or more outer update loop stopping criteria is met.

2. The method of claim 1, wherein the one or more inner and outer update loop stopping criteria is one of
time,
a number of iterations,
a threshold for a set of values that are calculated based on solution update values,
a threshold for a set of values that are calculated based on residual values or
a combination thereof.

3. The method of claim 1, wherein the analog accelerator is one of photonic accelerator, a neuromorphic accelerator, a neuromemristive accelerator, a biochemical accelerator, a biomechanical accelerator, an analog AI accelerator, or a combination thereof.

4. The method of claim 1, wherein a set of residue values and other set of input values for the inner residual loop are updated with a deterministic calculation or a calculation including randomness.

5. The method of claim 1, wherein the receiving of the set of one or more equations includes receiving is one of linear equations or a set of near linear equations.

6. The method of claim 1, wherein the analog accelerator uses coherent mixing in computing large scale linear computations, such as vector-vector, matrix-vector, matrix-matrix, or tensor-tensor multiplications.

7. The method of claim 6, wherein the analog accelerator uses a degree of freedom in light to encode thereof is one of a wavelength, a spatial mode, a polarization, and a component of a wave vector, or a combination thereof.

8. The method of claim 6, wherein the analog accelerator produces an analog signal which is converted to a fixed-point digital signal with an exponent bit to encode a range of the fixed-point digital signal.

9. The method of claim 8, wherein the range of the fixed-point digital signal is determined by one of i) a current analog signal, ii) a calculation on a digital component of the fixed-point digital signal with a value from a previous iteration, or iii) a combination of both.

10. The method of claim 9, wherein the digital computing device adjusts a value of the range.

11. The method of claim 10, wherein the analog accelerator uses only a value from fixed-point bits and does not use a value from exponent bits.

12. The method of claim 1, wherein the digital computing device produces a dynamic fixed-point digital signal which is converted to an analog signal that feeds back to the analog accelerator.

13. The method of claim 1, wherein the residual iterative algorithm solves an equation corresponding to an optimization problem.

14. The method of claim 1, wherein at least a portion of the inner residual loop is computed in parallel and independently from other inner residual loop computations using analog parallel computational techniques.

15. A hybrid analog and digital computational system comprising:
a digital computing device to implement a residual iterative algorithm that solves a set of solution values for a set of one or more equations, the residual iterative algorithm includes an outer update loop with a set of residue values initially set to a first initial value and a set of solution update values set to a second initial value;
an analog accelerator for implementing an inner residual loop of the residual iterative algorithm, the inner residual loop is iteratively computed until one or more inner residual loop stopping criteria is met, returning set of solution update values; and
control logic that uses the set of solution update values which has been computed to update the set of residue values and a range of a next set of solution update values, thereby adjusting a computational precision of the inner residual loop, and repeating computations of the outer update loop and the inner residual loop until one or more outer update loop stopping criteria is met.

16. The system of claim 15, wherein the one or more inner and outer update loop stopping criteria is one of
time,
a number of iterations,
a threshold for a set of values that are calculated based on solution update values,
a threshold for a set of values that are calculated based on residual values or
a combination thereof.

17. The system of claim 15, wherein the analog accelerator is one of photonic accelerator, a neuromorphic accelerator, a neuromemristive accelerator, a biochemical accelerator, a biomechanical accelerator, and an analog AI accelerator, or a combination thereof.

18. The system of claim 15, wherein a set of residue values and other set of input values for the inner residual loop are updated with a deterministic calculation or a calculation including randomness.

19. The system of claim 15, wherein the set of one or more equations includes one of a set of linear equations or a set of near linear equations.

20. The system of claim 15, wherein the analog accelerator uses coherent mixing in computing large scale linear computations, such as vector-vector, matrix-vector, matrix-matrix, or tensor-tensor multiplications.

21-28. (canceled)
